(19) United States
(12) Patent Application Publication
(10) Pub. No.: US 2018/0212357 A1
(43) Pub. Date: Jul. 26, 2018

(54) POWER CONNECTOR MODULE AND POWER CONNECTOR THEREOF

(71) Applicant: ASIAN POWER DEVICES INC., Taoyuan City (TW)

(72) Inventors: Kuang-Yi KAO, Taoyuan City (TW); Shao-Yu TSENG, Taoyuan City (TW)

(21) Appl. No.: 15/588,674

(22) Filed: May 7, 2017

(30) Foreign Application Priority Data
Jan. 20, 2017 (TW) 106201116

(51) Int. Cl. H01R 13/52

(52) U.S. Cl. CPC H01R 13/5219; H01R 13/521

(57) ABSTRACT

Disclosed are a power connector module and a power connector thereof, and the power connector includes an insulating body, a conductive structure and a waterproof cushion. The insulating body has a groove and a bottom wall formed inside the groove, and the bottom wall has one or more penetrating holes; the conductive structure includes one or more conductive terminals, and the conductive terminal is plugged and fixed into the penetrating hole and protruded from the bottom wall; and the waterproof cushion has one or more through holes for passing and installing the conductive terminal. If the waterproof cushion is pressed and deformed, the periphery of the conductive terminal will be in a sealed status to achieve the effect of providing a waterproof function to the power connector module and the power connector and improve the safety of use.

### FIELD OF THE INVENTION

This disclosure relates to a connector, and more particularly to a power connector module and a power connector thereof.

### BACKGROUND OF THE INVENTION

When an adapter of an electric appliance cannot fit AC cables of specifications and sizes of different countries, an AC inlet is generally installed to the adapter, and the specification conversion function of the AC inlet is used to connect the AC cable, so that the adapter and the AC cable can be electrically coupled by the AC inlet.

However, the conventional AC inlet does not come with a waterproof structure or a waterproof function, so that the AC inlet has an electric leakage or short circuit issue when it is used in a wet place such as a bathroom or a balcony. To improve the safety of the AC inlet, the AC inlet is designed with the waterproof function, and it becomes a main research and development subject for related manufacturers.

In view of the aforementioned drawbacks of the prior art, the discloser of this disclosure conducted extensive research and provided a feasible design to overcome the drawbacks of the prior art.

### SUMMARY OF THE INVENTION

Therefore, it is a primary objective of the present invention to provide a power connector module and a power connector having a waterproof cushion deformable when being pressed, so that the periphery of the conductive terminal is in a closed status to achieve a waterproof function and improve the safety of use of the power connector module and the power connector.

To achieve the aforementioned and other objectives, this disclosure provides a power connector comprising, an insulating body, having a groove, and a bottom wall formed inside the groove and having at least one penetrating hole on the bottom wall; a conductive structure, including at least one conductive terminal, plugged and fixed into the penetrating hole and protruded from the bottom wall; and a waterproof cushion, having at least one through hole for passing and installing the conductive terminal.

To achieve the aforementioned and other objectives, this disclosure also provides a power connector module comprising: a power connector, including:

an insulating body, having a groove, and a bottom wall formed inside the groove and having at least one penetrating hole on the bottom wall; a conductive structure, including at least one conductive terminal, plugged and fixed into the penetrating hole and protruded from the bottom wall; a waterproof cushion, having at least one through hole for passing and installing the conductive terminal; and a power plug, detachably plugged into the groove and electrically coupled to the conductive terminal, and the waterproof cushion being forcibly clamped between the bottom wall, the conductive terminal, and the power plug.

### BRIEF DESCRIPTION OF THE DRAWINGS

FIG. 1 is an exploded view of a power connector of this disclosure;

FIG. 2 is a sectional exploded of a power connector module of this disclosure; and

FIG. 3 is sectional perspective view of a power connector module of this disclosure.

### DESCRIPTION OF THE PREFERRED EMBODIMENTS

The technical contents of the present invention will become apparent with the detailed description of preferred embodiments accompanied with the illustration of related drawings as follows. It is noteworthy that the preferred embodiments are provided for illustrating this disclosure rather than restricting the scope of the disclosure.

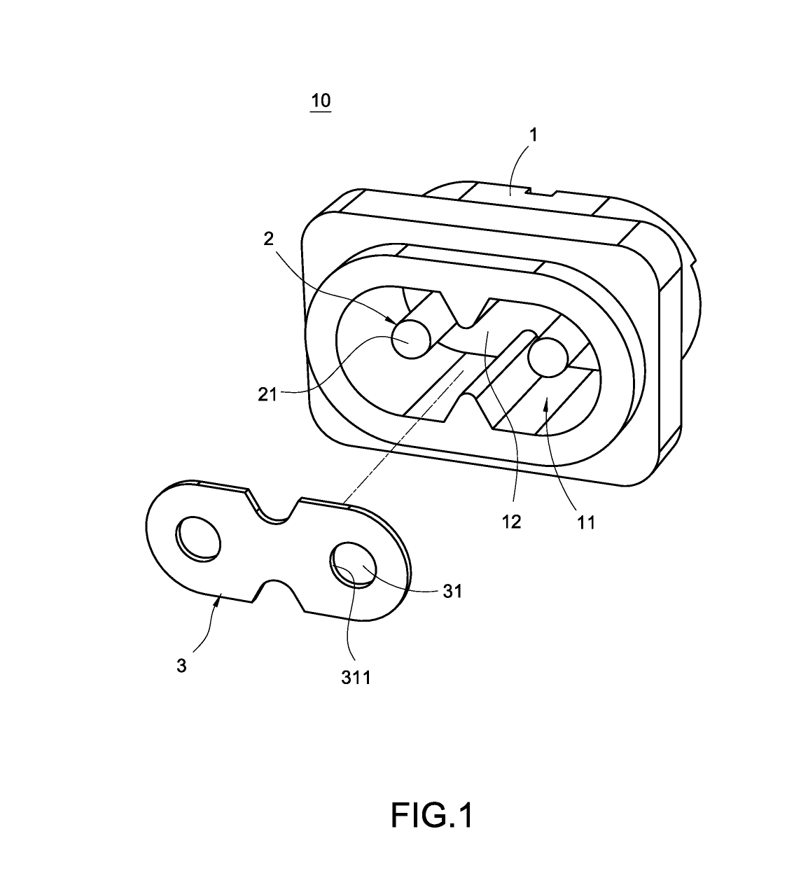

With reference to FIGS. 1 to 3 for a power connector module and a power connector thereof in accordance with this disclosure, the power connector module 100 comprises a power connector 10 and a power plug 20; and the power connector 10 comprises an insulating body 1, a conductive structure 2 and a waterproof cushion 3.

In FIGS. 1 to 3, the insulating body 1 has a groove 11 and a bottom wall 12 formed inside the groove 11, and the bottom wall 12 has one or more penetrating holes 121, and the exterior of the insulating body 1 has an outer side 13 with the penetrating hole 121 passing through.

In FIGS. 1 to 3, the conductive structure 2 includes one or more conductive terminals 21 and one or more conductive plates 22, and the conductive terminal 21 is plugged and fixed into the penetrating hole 121 and protruded from the bottom wall 12, and the conductive plate 22 is fixed to an outer side 13 of the insulating body 1 and electrically coupled to the conductive terminal 21. Wherein, the conductive terminal 21, the conductive plate 22 and the penetrating hole 121 have the same quantity.

In FIGS. 1 to 3, the waterproof cushion 3 is formed on the bottom wall 12, and the waterproof cushion 3 has one or more through holes 31 for passing and installing the conductive terminal 21, and an inner peripheral wall 311 of the through hole 31 is attached to an outer periphery of the conductive terminal 21. Wherein, the through hole 31 and the conductive terminal 21 have the same quantity.

In addition, the waterproof cushion 3 may be formed on the bottom wall 12 by an adhesive method or a coated injection molding method, and the waterproof cushion 3 is made of a soft waterproof material such as silicone and rubber.

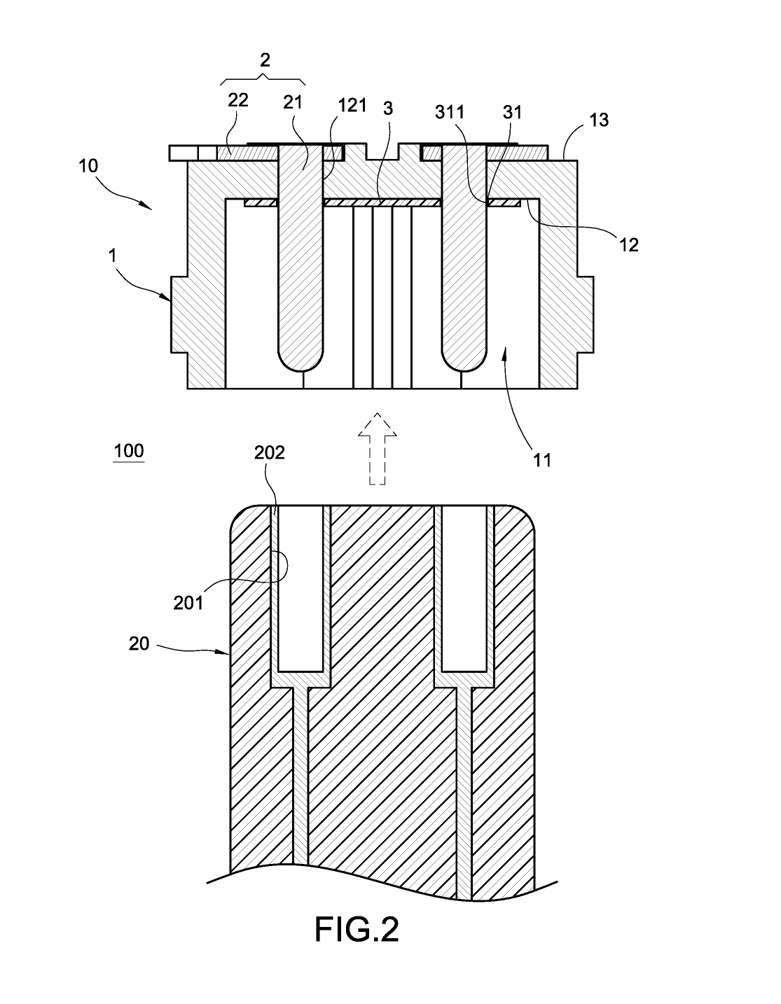

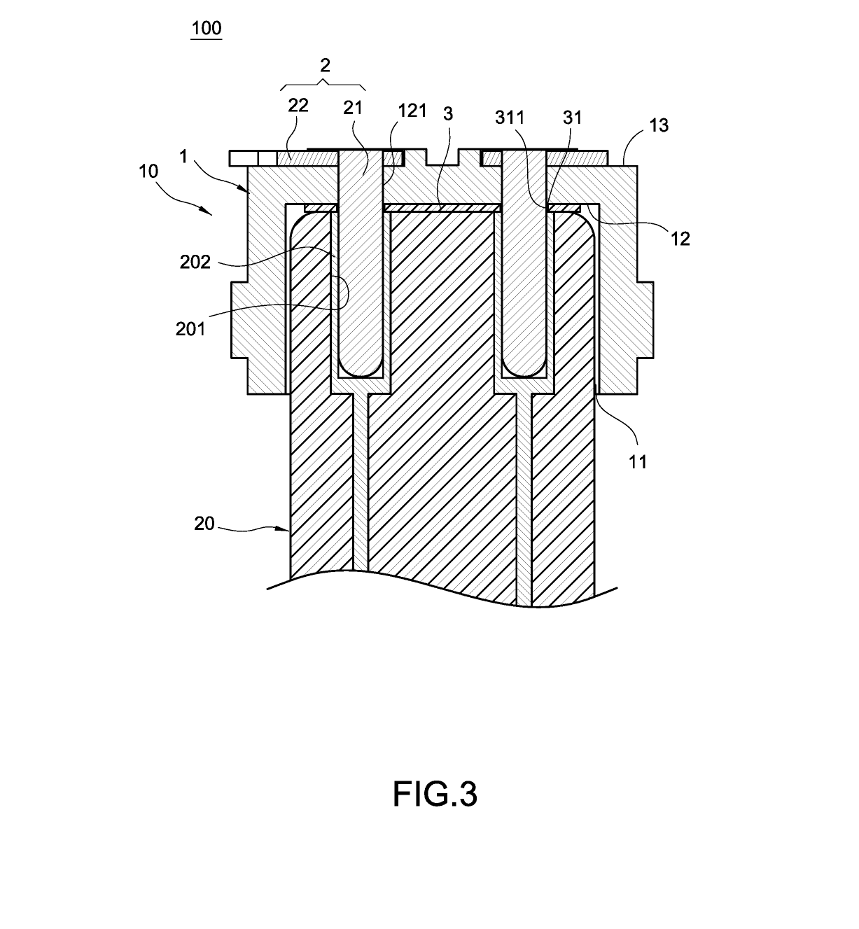

In FIGS. 2 and 3, the power plug 20 is detachably plugged into groove 11 and electrically coupled to the conductive terminal 21, and the waterproof cushion 3 is forcibly clamped between the bottom wall 12, the conductive terminal 21 and the power plug 20.

Specifically, the power plug 20 has one or more jacks 201, and each jack 201 has a conductive part 202 installed therein, and the conductive terminal 21 is passed and installed to the jack 201 and electrically coupled to the conductive part 202. Wherein, the jack 201 and the conductive terminal 21 have the same quantity.

With reference to FIGS. 2 and 3 for the combination of the power connector module 100 and the power connector 10, the power connector 10 includes the insulating body 1, the conductive structure 2 and the waterproof cushion 3; and the power connector module 100 includes the power connector 10 and the power plug 20, and the insulating body 1 has the groove 11 and the bottom wall 12 formed inside the groove 11, and the bottom wall 12 has the penetrating hole 121, and the conductive structure 2 includes the conductive terminal 21 plugged and fixed into the penetrating hole 121 and protruded form the bottom wall 12, and the waterproof cushion 3 has a through hole 31 for passing and installing the conductive terminal 21, and the power plug 20 is detachably plugged into groove 11 and electrically coupled to the conductive terminal 21, and the waterproof cushion 3 is forcibly clamped between the bottom wall 12, the conductive terminal 21 and the power plug 20.

With reference to FIG. 3 for the application of the power connector module 100 and the power connector 10 in accordance with this disclosure, when the power plug 20 is plugged into the groove 11, the power plug 20 will press the waterproof cushion 3, so that the waterproof cushion 3 is slightly deformed to attach the bottom wall 12 and the conductive terminal 21 closely, while the waterproof cushion 3 is attached and sealed with the periphery of the conductive terminal 21, and thus the periphery of the conductive terminal 21 is in a sealed status to achieve the water function of the power connector module 100 and the power connector 10 and improve the safety of use.

In summation of the description above, this disclosure achieves the expected effects, overcomes the drawbacks of the prior art, and complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A power connector, comprising:
an insulating body, having a groove, and a bottom wall formed inside the groove and having at least one penetrating hole on the bottom wall;
a conductive structure, including at least one conductive terminal, plugged and fixed into the penetrating hole and protruded from the bottom wall; and
a waterproof cushion, having at least one through hole for passing and installing the conductive terminal.

2. The power connector of claim 1, wherein the waterproof cushion is formed on the bottom wall and an inner peripheral wall of the through hole is attached to an outer periphery of the conductive terminal.

3. The power connector of claim 2, wherein the insulating body has an outer side with the penetrating hole passing through, and the conductive structure further includes at least one conductive plate fixed to the outer side and electrically coupled to the conductive terminal.

4. The power connector of claim 3, wherein the waterproof cushion is formed on the bottom wall by an adhesive method.

5. The power connector of claim 3, wherein the waterproof cushion is formed on the bottom wall by a coated injection molding method.

6. A power connector module, comprising:
a power connector, including:
an insulating body, having a groove, and a bottom wall formed inside the groove and having at least one penetrating hole on the bottom wall;
a conductive structure, including at least one conductive terminal, plugged and fixed into the penetrating hole and protruded from the bottom wall;
a waterproof cushion, having at least one through hole for passing and installing the conductive terminal; and
a power plug, detachably plugged into the groove and electrically coupled to the conductive terminal, and the waterproof cushion being forcibly clamped between the bottom wall, the conductive terminal, and the power plug.

7. The power connector of claim 6, wherein the waterproof cushion is formed on the bottom wall and an inner peripheral wall of the through hole is attached to an outer periphery of the conductive terminal.

8. The power connector of claim 7, wherein the insulating body has an outer side with the penetrating hole passing through, and the conductive structure further includes at least one conductive plate fixed to the outer side and electrically coupled to the conductive terminal.

9. The power connector module of claim 8, wherein the power plug has at least one jack, and the jack has a conductive part disposed inside, and the conductive terminal is passed and installed to the jack and electrically coupled to the conductive part.

10. The power connector module of claim 8, wherein the waterproof cushion is formed on the bottom wall by an adhesive method or a coated injection molding method.
